(19) United States
(12) Patent Application Publication
(10) Pub. No.: US 2006/0200608 A1
(43) Pub. Date: Sep. 7, 2006

(54) BUS ARBITER AND BUS ARBITRATING METHOD

(76) Inventors: Shih-Wei Peng, Taoyuan County (TW); Zou-Ping Chen, Tai-Chung City (TW); DeHuei Chen, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/164,532

(22) Filed: Nov. 28, 2005

(30) Foreign Application Priority Data
Nov. 30, 2004 (TW) 093136895

(51) Int. Cl. G06F 13/36

(52) U.S. Cl. 710/113

(57) ABSTRACT

A bus arbiter includes a counter circuit for generating a plurality of output values, wherein each of the output values is generated according to the number of times that one of a plurality of master devices utilizes a bus; and a control circuit for enabling one of the master devices to utilize the bus.

### BACKGROUND OF THE INVENTION

1. Field of the Invention

The present invention relates to bus control, and more particularly, to a bus arbiter and a bus device.

2. Description of the Prior Art

In a bus system of the prior art, when a plurality of master devices request to utilize a bus at the same time, the bus system typically determines which of the master devices will utilize the bus according to predetermined priorities of these master devices. Please refer to U.S. Pat. No. 6,633,939 titled “Variable-priority arbitration method and respective system” for more information. As master devices having higher priority may occupy the bus most of the time, some master devices having lower priority may have no chance to utilize the bus.

In the related art, round robin control can be utilized for alternately giving each master device the highest priority. Please refer to U.S. Pat. No. 6,665,760 titled “Group shifting and level shifting rotational arbiter system” for further information. Regarding the round robin control, if a master device requests to utilize the bus at a time just after the highest priority for said master device is taken away, the master device has to compete with others in order to utilize the bus. Typically, the master device must wait until the next time when the highest priority is given to the master device again.

### SUMMARY OF THE INVENTION

It is an objective of the claimed invention to provide bus arbiters, bus devices, and bus arbitrating methods.

According to one embodiment of the claimed invention, a bus arbiter is disclosed. The bus arbiter comprises a counter circuit for generating a plurality of output values. Each of the output values is generated according to the number of times that one of a plurality of master devices utilizes a bus. The bus arbiter further comprises a control circuit for enabling one of the master devices to utilize the bus according to the output values.

According to one embodiment of the claimed invention, a bus arbitrating method is disclosed. The bus arbitrating method comprises: generating a plurality of output values, each of the output values being corresponding to the number of times that one of a plurality of master devices utilizes a bus; andenabling one of the master devices to utilize the bus according to the output values.

These and other objectives of the claimed invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a bus system of the present invention.

FIG. 2 is a diagram of a bus arbiter of a first embodiment of the present invention.

FIG. 3 is a table utilized by the logic circuit shown in FIG. 2.

FIG. 4 is a diagram of a bus arbiter of a second embodiment of the present invention.

### DETAILED DESCRIPTION

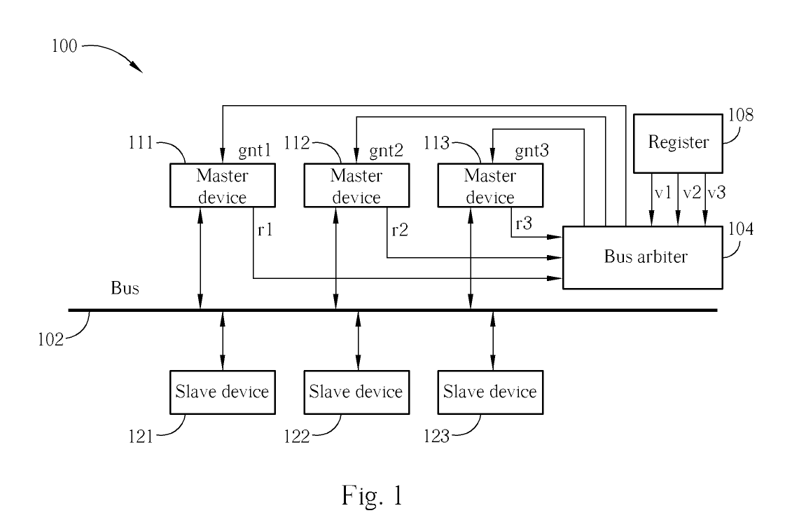

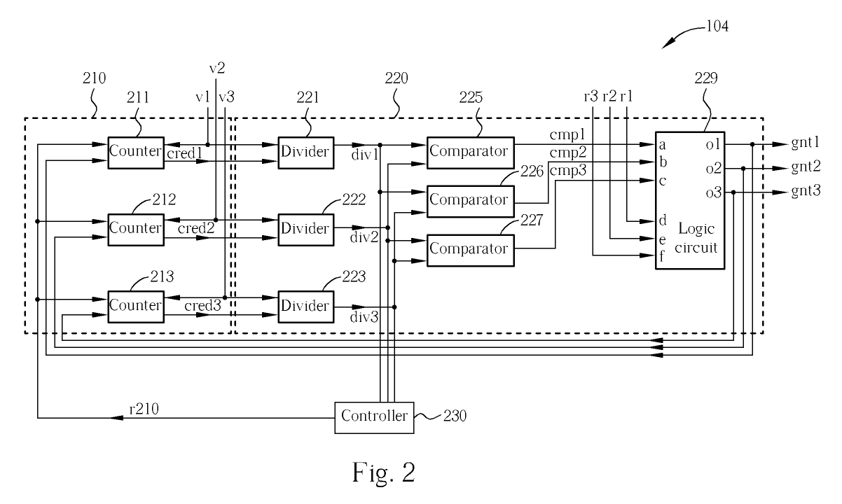

Please refer to FIG. 1 and FIG. 2. FIG. 1 is a diagram of a bus system 100 of the present invention. FIG. 2 is a diagram of a bus arbiter 104 of a first embodiment of the present invention. The bus system 100 comprises a bus 102, the bus arbiter 104, a register 108, a plurality of master devices 111, 112, and 113, and a plurality of slave devices 121, 122, and 123. Accessing signals between any of the master devices 111, 112, and 113 and any of the slave devices 121, 122, and 123, e.g. control signals and data flows, can be transmitted through the bus 102.

As shown in FIG. 2, the bus arbiter 104 comprises a counter circuit 210, a control circuit 220, and a controller 230, wherein the counter circuit 210 comprises a plurality of counters 211, 212, and 213, and the control circuit 220 comprises a plurality of arithmetic units, which are the dividers 221, 222, and 223 in this embodiment, a plurality of comparators 225, 226, and 227, and a logic circuit 229. In this embodiment, the bus system 100 can be installed in a computer system or an embedded system of a consumer electronic product. This is not a limitation of the present invention.

When needing to utilize the bus 102 in order to communicate with one of the slave devices 121-123, one of the master devices 111-113 drives a corresponding request signal r1, r2, or r3 from a level r_L to another level r_H. For example, when the master device 111 needs to utilize the bus 102, the master device 111 drives the request signal r1 to the bus arbiter 104.

In addition, the bus arbiter 104 is capable of driving one of a plurality of grant signals gnt1, gnt2, and gnt3 from a level g_L to another level g_H, whereby the bus arbiter 104 grants one of the master devices 111-113 the priority to utilize the bus 102. For example, the bus arbiter 104 grants the master device 111 the utilization of the bus 102 by driving the grant signal gnt1 from the level g_L to the level g_H.

In this embodiment, the level g_L represents the logic value 0, and the level g_H represents the logic value 1. This is not a limitation of the present invention.

In this embodiment, the register 108 stores a plurality of predetermined values v1, v2, and v3, which are respectively outputted to the counters 211-213 and dividers 221-223. The predetermined values v1, v2, and v3 respectively represent the number of times that the master devices 111-113 should utilize the bus 102 in a round, where the predetermined values v1, v2, and v3 can be determined according to trial experiments for deriving the bus-utilizing probabilities (i.e. the probabilities of utilizing the bus 102 in this embodiment) of the master devices 111-113. For example, (v1, v2, v3)=(5, 3, 2), meaning the master devices 111-113 may utilize the bus 102 five times, three times, and two times respectively in a round or in a time interval. In addition, other kinds of storage components can be utilized for replacing the register 108 mentioned above.

According to this embodiment, a plurality of values cred1, cred2, and cred3 stored and outputted from the counters 211-213 respectively represent the remaining number of times that the master devices 111-113 should utilize the bus 102 in this round. The bus-utilizing priorities (i.e. the priorities of utilizing the bus 102) of the master devices 111-113 respectively correspond to the output values cred1, cred2, and cred3, and more particularly, to the output values cred1, cred2, and cred3 and the predetermined values v1, v2, and v3 in this embodiment. By resetting the counters 211-213 utilizing the reset signal r210, the values cred1, cred2, and cred3 stored in the counters 211-213 can be set to be the predetermined values v1, v2, and v3, respectively. The values cred1, cred2, and cred3 may decrease in accordance with the increase of the number of times that the corresponding master devices 111-113 have utilized the bus 102 in this round. For example, when the bus arbiter 104 grants the master device 111 its request of utilizing the bus 102, the grant signal gnt1 outputted to the counter 211 is driven from the level g_L to the level g_H. After receiving the grant signal gnt1 having the level g_H, the counter 211 alters the value cred1 stored therein with a decrement of one. Therefore, in this embodiment, by decreasing the value cred1 stored in the counter 211, the remaining number of times that the master device 111 should utilize the bus 102 can be counted. Operation principles of the counters 212 and 213 are similar to those of the counter 211, and therefore not explained in detail here.

In this embodiment, while determining the bus-utilizing priorities of the master devices 111-113, the dividers 221-223 respectively perform divide operations on the values cred1, cred2, and cred3 outputted from the counters 211-213 and the predetermined values v1, v2, and v3, to generate a plurality of calculation results div1, div2, and div3. According to this embodiment, the calculation results div1, div2, and div3 represent the bus-utilizing priorities of the master devices 111-113, respectively. One of the various implementation choices of the divide operations can be described by the following equations:
div1=cred1/v1;
div2=cred2/v2;
div3=cred3/v3.

Additionally, the comparators 225-227 compare any two of the calculation results div1, div2, and div3, to generate comparison signals cmp1, cmp2, and cmp3, respectively. Regarding the comparator 225, if the calculation result div1 received by the comparator 225 is greater than or equal to the calculation result div2, i.e. the bus-utilizing priority of the master device 111 is considered to be higher than that of the master device 112 in this case, then the comparison signal cmp1 outputted by the comparator 225 corresponds to the logic value 1; otherwise, the comparison signal cmp1 outputted by the comparator 225 corresponds to the logic value 0. Operation principles of the comparators 226 and 227 are similar to those of the comparator 225.

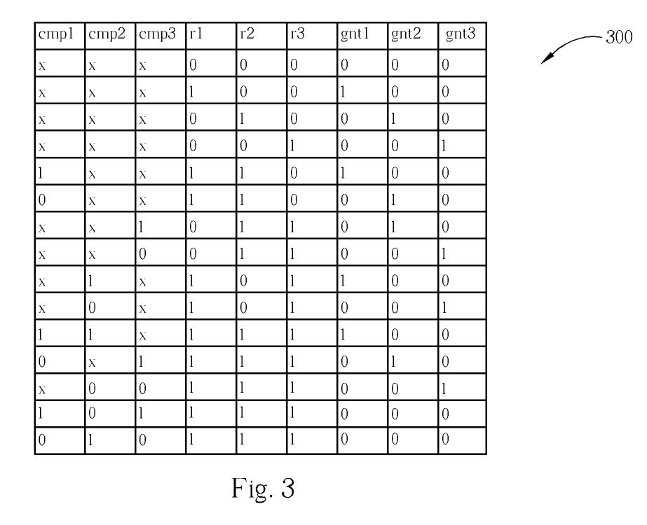

In this embodiment, the logic circuit 229 of the bus arbiter 104 may utilize a table, e.g. the table 300 shown in FIG. 3, to determine the logic values of the grant signals gnt1, gnt2, and gnt3 according to the logic values of the comparison signals cmp1, cmp2, and cmp3 and the logic values of the request signals r1, r2, and r3, where the table 300 of this embodiment stores the mapping relationships among the comparison signals cmp1, cmp2, and cmp3, the request signals r1, r2, and r3, and the grant signals gnt1, gnt2, and gnt3. The master devices 111-113 determine whether to utilize the bus 102 according to the grant signals gnt1, gnt2, and gnt3 outputted by the logic circuit 229. In addition, this is not a limitation of the present invention. This is one of the various implementation choices of the present invention. For example, the logic circuit in an embodiment of the present invention is capable of determining the logic values of the grant signals gnt1, gnt2, and gnt3 according to the logic values of the comparison signals cmp1, cmp2, and cmp3.

As mentioned, in the bus arbiter 104, the counters 211-213 stores the remaining number of times that the master devices 111-113 should utilize the bus 102, i.e. the values cred1, cred2, and cred3; the dividers 221-223 derive the calculation results div1, div2, and div3 according to the values cred1, cred2, and cred3 and the predetermined values v1, v2, and v3, which are the number of times that the master devices 111-113 should utilize the bus 102 in a round; the comparators 225-227 compare the calculation results div1, div2, and div3 with each other to output the comparison signals cmp1, cmp2, and cmp3; the logic circuit 229 outputs the grant signals gnt1, gnt2, and gnt3 according to the comparison signals cmp1, cmp2, and cmp3 and the request signals r1, r2, and r3 of the master devices 111-113.

In an embodiment, if either all the master devices 111-113 have used up the number of times that they should utilize the bus 102 in this round, or any of the master devices 111-113 requests to utilize the bus 102 while the corresponding number of times that it should utilize the bus 102 in this round has been used up, (e.g., the master device 111 requests to utilize the bus 102 while the value cred1 is zero), then the controller 230 is capable of generating the reset signal r210 according to the calculation results div1, div2, and div3 to reset the counters 211-213.

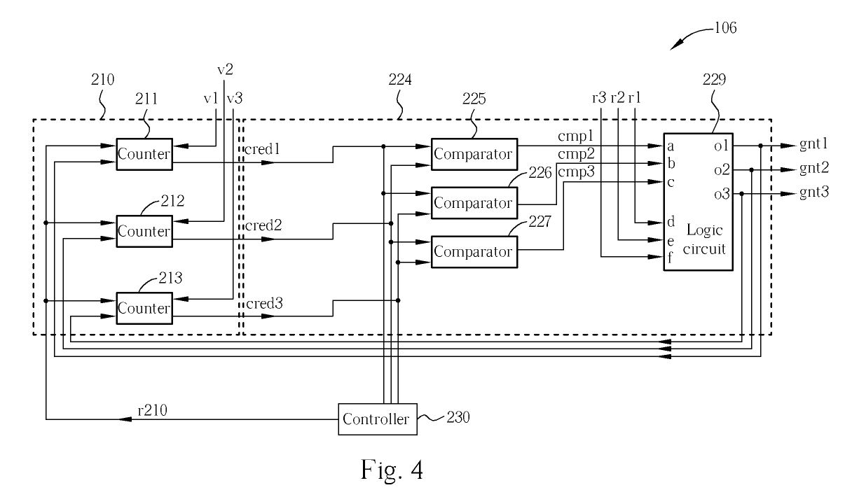

FIG. 4 is a diagram of a bus arbiter 106 according to a second embodiment of the present invention. In the second embodiment, the arithmetic units such as the dividers 221-223 shown in FIG. 2 can be omitted. That is, the comparators 225-227 shown in FIG. 4 directly compare any two of the values cred1, cred2, and cred3 outputted from the counters 211-213, to determine the levels of the comparison signals cmp1, cmp2, and cmp3. It should be noted that the operation of the controller 230 in this embodiment is similar to that in the first embodiment.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A bus arbiter, comprising:
a counter circuit for generating a plurality of output values, each of the output values being generated according to the number of times that one of a plurality of master devices utilizes a bus; and
a control circuit coupled to the counter circuit, for enabling one of the master devices to utilize the bus according to the output values.

2. The bus arbiter of claim 1, wherein the control circuit enables one of the master devices to utilize the bus according to the output values and a plurality of predetermined values corresponding to the master devices.

3. The bus arbiter of claim 2, wherein the control circuit comprises:
a plurality of arithmetic units coupled to the counter circuit for generating a plurality of calculation results according to a plurality of predetermined values and the output values;
at least one comparator coupled to the arithmetic units for comparing two of the calculation results to generate at least one comparison signal; and
a logic circuit coupled to the comparator for enabling one of the master devices to utilize the bus according to the comparison signal.

4. The bus arbiter of claim 3, wherein the arithmetic units are dividers.

5. The bus arbiter of claim 3, wherein the logic circuit enables one of the master devices to utilize the bus according to the comparison signal and at least one request signal generated by at least one of the master devices.

6. The bus arbiter of claim 1, wherein the control circuit comprises:
at least one comparator coupled to the counter circuit for comparing two of the output values to generate at least one comparison signal; and
a logic circuit coupled to the comparator for enabling one of the master devices to utilize the bus according to the comparison signal.

7. The bus arbiter of claim 6, wherein the logic circuit enables one of the master devices to utilize the bus according to the comparison signal and at least one request signal generated by at least one of the master devices.

8. A bus device, comprising:
a bus coupled to a plurality of master devices; and
a bus arbiter, comprising:
a counter circuit for generating a plurality of output values, each of the output values being generated according to the number of times that one of the master devices utilizes the bus; and
a control circuit coupled to the counter circuit for controlling bus-utilizing priorities of the master devices according to the output values.

9. The bus device of claim 8, wherein the control circuit comprises:
a plurality of arithmetic units coupled to the counter circuit, for generating a plurality of calculation results according to the output values and a plurality of predetermined values corresponding to the master devices; and
a logic circuit coupled to the arithmetic units for controlling the bus-utilizing priorities of the master devices according to the calculation results.

10. The bus device of claim 9, wherein the arithmetic units are dividers.

11. The bus device of claim 9, wherein the logic circuit enables one of the master devices according to the calculation results and at least one request signal generated by at least one of the master devices.

12. The bus device of claim 8, wherein the control circuit comprises:
at least one comparator coupled to the counter circuit for comparing two of the output values to generate at least one comparison signal; and
a logic circuit coupled to the comparator for enabling one of the master devices to utilize the bus according to the comparison signal.

13. The bus device of claim 8, wherein the counter circuit counts the remaining number of times that the master devices should utilize the bus to generate the output values.

14. A bus arbitrating method, comprising:
generating a plurality of output values, each of the output values being generated according to the number of times that one of a plurality of master devices utilizes a bus; and
enabling one of the master devices to utilize the bus according to the output values.

15. The method of claim 14, wherein the one of the master devices is enabled according to the output values and a plurality of predetermined values.

16. The method of claim 15, wherein the enabling step further comprises:
calculating a plurality of calculation results according to the predetermined values and the output values; and
enabling one of the master devices to utilize the bus according to the calculation results.

17. The method of claim 16, wherein the one of the master devices is enabled according to the calculation results and at least one request signal corresponding to at least one of the master devices.

18. The method of claim 14, wherein the enabling step further comprises:
comparing two of the output values to generate at least one comparison signal; and
according to the comparison signal, enabling one of the master devices to utilize the bus.

19. The method of claim 18, wherein the one of the master devices is enabled according to the comparison signal and at least one request signal corresponding to at least one of the master devices.

20. The method of claim 14, wherein the enabling step further comprises:
calculating a plurality of calculation results according to the output values and a plurality of predetermined values corresponding to the master devices;
comparing two of the calculation results to generate at least one comparison signal; and
enabling one of the master devices to utilize the bus according to the comparison signal.
